(19) United States
(12) Patent Application Publication
(10) Pub. No.: US 2022/0277387 A1
(43) Pub. Date: Sep. 1, 2022

(54) AUTOMATICALLY GENERATING OPTIMIZED DATA STRUCTURE OBJECTS

(71) Applicant: Capital One Services, LLC, McLean, VA (US)

(72) Inventors: Drake R. SANDERSON, The Colony, TX (US); Rukmani THIRUPPATHI, Plano, TX (US); Adam GERNES, Plano, TX (US); Krishna Mohan BIBIREDDY, Mckinney, TX (US); Taylor Elliott GERON, Plano, TX (US); Thomas BUSATH, Celina, TX (US); Jonathan LAI, The Colony, TX (US); Abhishek TEWARI, Plano, TX (US)

(73) Assignee: Capital One Services, LLC, McLean, VA (US)

(21) Appl. No.: 17/187,038

(22) Filed: Feb. 26, 2021

(51) Int. Cl. G06Q 40/02; G06F 16/22; G06F 9/451; G06F 16/28

(52) U.S. Cl. CPC G06Q 40/025; G06F 16/2264; G06F 9/451; G06F 16/288; G06Q 30/01

(57) ABSTRACT

Disclosed herein are system, method, and computer program product embodiments for generating optimized data structure objects. In a given embodiment, a server receives a request to identify a set of data structure objects from a plurality of data structure objects for a specified vehicle and a specified user and based on user objective data and an attribute. The server may generate the plurality of data structure objects within constraints of the user objective data, policy data, and the attribute. The server may identify the set of data structure objects from the plurality of data structure objects. Each data structure object of the set is within a threshold distance to a value of at least one dimension of a set of the dimensions of the set of dimensions of a model.

### BACKGROUND

When a customer attempts to purchase a vehicle from a car dealership, the car dealership can generate a pricing option for the customer in coordination with a lender. The pricing option may include loan information (that meets lender requirements) and vehicle price information for the vehicle. The customer may want to change the pricing option elements, such as loan term, vehicle price (e.g., through negotiation), interest rates, or the like, so that the customer can meet their personal payment preference. However, the customer and the dealer are often inaccurately guessing which elements of the pricing option can be adjusted (and the net effects of the adjustments) while remaining within the constraints of the customer's preferences and continuing to meet lender requirements. Furthermore, the pricing option may not be specifically tailored to the customer.

Once a customer has expressed interest in a vehicle, it is beneficial for the car dealership to structure the pricing option to close the sale. A final pricing option offered by the car dealership may be different than the pricing option initially presented to the customer based on adjustments made during negotiations, which may result in the final pricing structure not meeting the customer's preferences, even if the pricing option initially presented to the customer did meet the customer's preferences. Therefore, approaches are needed to ensure that customers may be offered a pricing option that can be adjusted as needed while remaining within the constraints of the customer's preferences and a lender's requirements, reducing time and operational resources.

Moreover, there are a significant amount of operational resources wasted when attempting to guess or estimate how much to vary a value in a pricing option so that it meets the requirements of the customer and the dealer. Repeatedly processing requests for generating pricing options for a vehicle may be a time-consuming and cumbersome process. Moreover, the pricing options that are generated do not accurately match the customer or dealer's preferences. Therefore, approaches are needed to ensure that the dealer or customer are not blindly transmitting multiple requests to generate pricing options for a vehicle.

### BRIEF DESCRIPTION OF THE DRAWINGS

The accompanying drawings are incorporated herein and form a part of the specification.

FIG. 1 is a block diagram of a system for generating optimized data structure objects, according to some embodiments.

FIG. 2 is a block diagram illustrating the data flow in the system for generating optimized data structure objects, according to some embodiments.

FIGS. 3A-3B illustrate example user interfaces for generating optimized data structure objects, according to some embodiments.

FIG. 4 illustrates a model for identifying the set of data object structures, according to some embodiments.

FIG. 5 is a flowchart illustrating a process for generating and identifying a set of data structure objects, according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for generating optimized data structure objects.

When a potential customer (e.g., a user) walks into a dealership (e.g., a car dealership), a dealer representing the dealership wants to be in the best possible position to close a sale. In the case of a car dealership, this means showcasing available vehicles to the customer and having the customer agree to purchase a particular vehicle, and working with the customer to agree on financial terms for the purchase that meet the customer's goals.

Moreover, when obtaining financing for purchasing a vehicle, the user, dealer, lender, may all have separate objectives. For example, the dealership may generate a loan offer for a user to purchase a vehicle. The dealership may transmit the loan offer to the lender for approval, however, the loan offer may be outside the constrains of the lender policy, user objectives, etc. As a result, the relationship manager may reject the loan offer. At this point, conventional systems require relationship managers to physically call the dealer and estimate values for loan offers that may be acceptable to the lender. However, these estimated values may be outside the constrains of the user's or dealer's objectives. This may be a very inefficient and computationally expensive system. Therefore, it may be important to understand each of these objectives when generating counter offers for the loan offers, so that there is a high likelihood for the lender, dealer, and user to accept the loan offer.

The method, system, and non-transitory computer-readable medium embodiments described herein solve these problems by generating an optimized set of data structure objects. Data structure objects may be data structures configured to store multiple different elements of data. For example data structure objects may be a unitary data structure such as a JavaScript Object Notation (JSON) object, array, record, object, etc. The method, system, and non-transitory computer-readable medium embodiments described herein may generate and identify data structure objects which store data corresponding to the requirements/preferences of a user and a seller.

In an embodiment, a server receives a request to identify a set of data structure objects from a plurality of data structure objects for a specified vehicle and a specified user and based on user objective data and an attribute. User objective data may be a requirement for generating and identifying the data structure objects. The user objective data may be a specific value. For example, the user objective data may be a maximum monthly payment amount, maximum interest rate, maximum loan term, or the like. The attribute may be a user or seller defined goal for a data structure object. For example, the attribute may be “low rate”, “low backend value”, “high front end value”, or the like.

The server may generate the plurality of data structure objects for the specified vehicle by adjusting a value for a parameter corresponding to the attribute by an incremental amount within a threshold while maintaining each data structure object of the plurality of data structure objects within constraints of the user objective data, policy data, and the attribute. The server may generate a model using the plurality of data structure objects. The model may include a set of dimensions, and the model may indicate a distance between each of the plurality of data structure objects and each of the set of dimensions on the model. The server may identify the set of data structure objects from the plurality of data structure objects. Each data structure object of the set is within a threshold distance of at least one of the dimensions of the set of dimensions of the model. The server may cause display of the set of data structure objects on a graphical user interface (GUI).

The above configuration allows for automatically generating multiple options or versions of data structure objects. The set of data structure objects may be a set of instant pricing structures for loans of vehicles. Moreover, the set of instant pricing structures may be within the constraints of the input associated with the user and lender policy and remaining consistent with the dealer's preferences. The set of instant pricing structures may be optimized so that each instant pricing structure of the set is selected based on a consistency of its parameters or based on providing the maximum value of the user's objective.

As a non-limiting example, the method, system, and non-transitory computer-readable medium embodiments described herein may be used by a relationship manager of a lender to generate optimized callbacks or counter offers to the dealership generated loan offer while remaining within the constraints of the user's objective, dealer's objectives, lender policy, etc. This results in a quicker acceptance of a potential loan offer that is acceptable to the dealer, lender, and user.

This configuration provides an increased likelihood that of one of the instant pricing structures is selected by both the user and a car dealer. As a result, this configuration avoids transmitting multiple requests to regenerate instant pricing structures. Thus, this configuration conserves extensive use of operational resources as compared to conventional systems.

Additionally, each of the instant pricing structures can be actionable as they are pre-generated based on a lender's underwriting and pricing algorithms. That is, an instant pricing structure, once selected, can share the same data (e.g., projected payments and APR information) as the final pricing structure data that is accepted by the lender. This ensures that the instant pricing structure does not change once the final pricing structure is generated. This way, each data structure object is a realistic pricing option for the vehicle. As such, rather than a dealer manually generating a pricing structure and making multiple requests to a lender (as is conventionally done) for pre-approval, this configuration generates multiple potential final pricing data structure objects based on a lender's underwriting and pricing algorithms with a single request. By generating actionable instant pricing structures, this configuration avoids unnecessarily processing data a repeated number of times, and therefore, conserves computational and operational resources as compared to conventional systems.

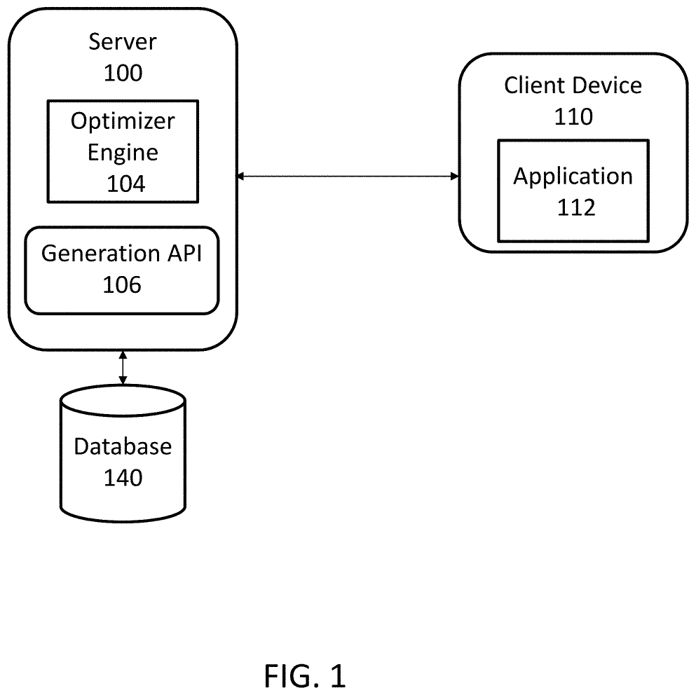

FIG. 1 is a block diagram of a system for generating optimized data structure objects, according to some embodiments. In an embodiment, the system can include a server 100, client device 110, and database 140. Server 100 may be in communication with generation API 106, client device 110, and database 140.

Server 100 can be connected with client device 110 and database 140 through wired connections, wireless connections, or a combination of wired and wireless connections. As an example, server 100 can be connected with client device 110 and database 140 through a network. The network can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

Client device 110 may be configured to transmit a request to server 100 to generate a set of data structure objects. A data structure object may be an instant pricing structure for a loan of a vehicle. More specifically, a loan contract for a given vehicle may include multiple elements of data. The data can include a vehicle's price, loan amount, APR, projected monthly payments, loan term, or the like. An instant pricing structure may be a unitary object that includes the multiple elements of data regarding the pricing of a loan contract for the given vehicle. Moreover, the instant pricing structure may include details of a loan offer for the given vehicle.

Database 140 may be configured to store data structure objects. Therefore, each data structure object or instant pricing structure may be stored in a single database record in database 140. This way, a data structure object or instant pricing structure can be easily retrieved from database 140.

The transmitted request from client device 110 may include an attribute, user objective data, and information about the specified vehicle and user. In response, server 100 may execute an optimizer engine 104 and generation API 106. Generation API 106 may generate a plurality of data structure objects for the specified vehicle and user based on the attribute, user objective data, and information about the specified vehicle and user.

Optimizer engine 104 may generate a model using the plurality of data structure objects. The model includes a set of dimensions and the plurality of data structure objects are plotted on the model with respect to the set of dimensions. Optimizer engine 104 may identify a set of data structure objects from the plurality of data structure objects. Each data structure object of the set is within a threshold distance to a value of at least one of the dimensions of the set of dimensions of the model. The distance may be a difference in the value of a given dimension and a value of a parameter of a data structure object that corresponds with the dimension.

Server 100 may transmit the set of data structure objects to client device 110. Client device 110 may display the set of data structure objects on a user interface (UI). Client device 110 may be a device operated by the user (e.g., customer or relationship manager of a lender) or a seller (e.g., car dealer). More specifically, client device 110 may execute a user application or a seller application. The application may be a web-based application. The user or seller application may render the UI. The user or seller may interface with the UI to transmit the request to generate and identify data structure objects. Furthermore, the set of data structure objects may be rendered on the UI. Alternatively, the UI may be rendered on a website, accessed through an internet browser.

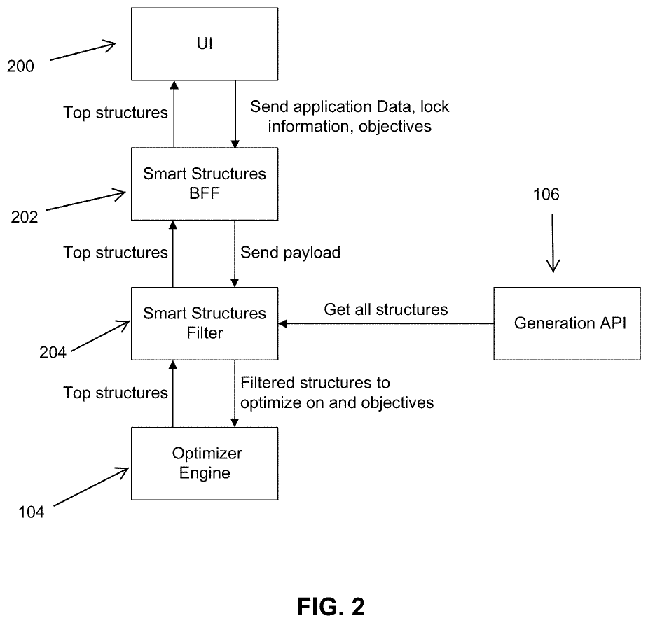

FIG. 2 is a block diagram illustrating the data flow in the system for generating optimized data structure objects, according to some embodiments. FIG. 2 will be described with respect to FIG. 1.

In a given embodiment, a user may interface with a vehicle dealership in-person or virtually using client device 110. A user may be interested in purchasing a given vehicle from an inventory of the vehicle dealership. Financing options for purchasing the vehicle may be provided to the user. The user may desire to generate a pricing option to project the cost of the vehicle. For example, the user may desire to project the monthly payments based on the vehicle's price and a loan amount. Furthermore, a user may desire to view different pricing options available to the user while staying within the constraints of an input associated with the user. The input may be a maximum desired monthly payment, maximum interest rate, loan term, vehicle price, or the like. The input may be user objective data.

As indicated above, the pricing options may be conveyed in a data structure object. The data structure object may be an instant pricing structure for a loan for the vehicle. The instant pricing structure may be a unitary data object. For example, instant pricing structure may be a unitary data structure such as a JSON object, array, record, object, or the like. Each instant pricing structure may contain data associated with a pricing option for a vehicle. The data can include a vehicle's price, loan amount, APR, projected monthly payments, loan term, or the like.

An instant pricing structure may be generated using various parameters. These parameters can include the term, sales price, cash down, trade value, warranty, gap, participation, rebate, alternative vehicles, etc. Each of the parameters may correspond with values that may affect the instant pricing structure.

A user may interface with UI 200 to transmit a request to generate and identify a set of data structure objects (i.e., a set of instant pricing structures). UI 200 may be rendered on client device 110. As indicated above, client device 110 may be a user device or a seller device. Moreover, UI 200 may be rendered on a user application executing on the user device or a seller application executing on a seller device. UI 200 may also be rendered on a website. Therefore, a user may interface with UI 200 on a seller's device at the vehicle dealership or on their user device at the vehicle dealership or any other location. Alternatively, a seller may interface with UI 200 using the seller device.

The request may be for generating instant pricing structures for a loan for a specified vehicle sold by a seller, such as a car dealer. The specified vehicle may be available at the dealership. In some embodiments, the instant pricing structures may be for products other than vehicles sold by a seller. The products may include real estate, retail products, or the like.

As indicated above, a user or dealer may transmit a request to generate and identify a set of instant pricing structures for a specified vehicle using UI 200. The request may include user information, vehicle information about the specified vehicle, user objective data, an attribute, locked-in values, etc. The user information may include the user's full name, social security number, address, employment information, or other personal information, such as would be needed for credit verification or vehicle purchase. The vehicle information about the specified vehicle may include VIN, make, model, year, cost, dealership identifier, etc.

The request may also include a user input specifying the user objective data. The user objective data may be used to further filter and refine the available instant pricing structure s. The user objective data can be a maximum monthly payment, interest rate, vehicle price, loan term, or the like.

The request may also include an attribute. The attributes may serve as constraints or requirements when generating instant pricing structure s. For example, attributes can include a ratio of the backend value of the sales price and the frontend value of the sales price, percentage of the sales price that is the backend value as compared to the total value of the vehicle, funded structured flag, the percentage of down payment, details related to the vehicle (e.g., condition of the vehicle, whether the vehicle is new or used, type of vehicle, or the like), or the like. The funded structured flag may indicate whether the dealer prefers protection for assuming the credit risk. The frontend value of the price of a vehicle may include the price of the vehicle itself. The backend value of the price of the vehicle may include warranties and maintenance of the vehicle. In some embodiments, the user can specify the attribute using UI 200. In other embodiments, the dealer can specify the attribute using UI 200.

Moreover, server 100 may identify an attribute. For example, the attribute may be a dealer's tendencies or preferences when agreeing upon a final pricing structure. Server 100 may identify an attribute based on previously agreed upon final pricing structures by the dealer. In some embodiments, server 100 may implement an unsupervised machine learning algorithm to identify attributes about the dealer based on the previously agreed upon final pricing structures.

Server 100 may receive the request from UI 200. Server 100 may include a smart structure Backend For Frontend (BFF) 202. Smart structures BFF 202 is a layer between the UI 200 and other resources such as, smart structures filter 204. The layer may be a shim. A shim may be a library that interfaces between UI 200 and other resources such as, smart structures filter 204. For example, smart structures BFF 202 may be a shim that translates any requests transmitted from UI 200 for smart structures filter 204 and translates any response from smart structures filter 204 for UI 200. A shim may require less code to implement as compared to an API. As such, using the shim may allow the architecture to run more efficiently. In some embodiments, different versions of smart structures BFF 202 may interface with UI 200, depending on whether the UI 200 is on a mobile device, or a desktop computer.

Smart structures BFF 202 may format user information, vehicle information about the specified vehicle, user objective data, an attribute, locked-in values, etc., into a payload and transmit the payload to smart structures filter 204. Smart structures filter 204 may also be an API on server 100.

Smart structures filter 204 may interface with generation API 106 to generate a plurality of data structure objects (i.e., instant pricing structures). Generation API 106 may reside in server 100 or outside server 100. Generation API 106 may use a dealer identifier to retrieve the inventory of the dealer. Generation API 106 may also use the dealer identifier to retrieve dealer information, including previously agreed upon final pricing structures, inventory information, sales records, or the like. Generation API 106 may use the inventory information to determine or confirm information about the specified vehicle. Generation API 106 may receive the dealer identifier in the request. Alternatively, generation API 106 may identify the dealer based on where the vehicle is currently listed in stock using the specified vehicle's information (e.g., VIN). Furthermore, generation API 106 may identify the dealer by identifying the seller device that transmitted the request. The seller device can correspond to a dealership.

Generation API 106 may retrieve the credit policy of a lender from database 140. A lender may provide their methodology and policies to database 140. As an example, server 100 and database 140 may be associated with the lender. Generation API 106 can retrieve a lender's policy and methodology for generating an instant pricing structure from database 140. The lender's policy and methodology can include Bayesian regression algorithms, decision trees, pricing grids, or various equations to generate instant pricing structures. As an example, the lender's methodology may include interfacing with a third-party credit bureau to execute a soft pull for the user. Soft pulls are soft credit inquiries that do not affect the user's credit score. The user information, soft pull information, input, and information about the given vehicle can be values of parameters used to generate the instant pricing structure using the lender's policies and methodologies. Each instant pricing structure can be specifically generated based on the user's unique information and the given vehicle.

Generation API 106 may generate a current instant pricing structure using the user information, information about the specified vehicle, the lender's credit policy, and default values for the parameters. The default values may be predetermined by the dealer, lender, user, or the like. Alternatively, generation API 106 may receive the current instant pricing structure as part of the request to generate a set of instant pricing structures. For example, a relationship manager working for the lender may be responsible for approving or rejecting instant pricing structures received from dealerships. The relationship manager may also be responsible for generating instant pricing structures for users purchasing vehicles. The instant pricing structures may be counter offers to the current instant pricing structure. The current instant pricing structure may be generated by the dealership and transmitted to the relationship manager for approval. The dealership may generate the current instant pricing structure using information about the specified vehicle, the lender's credit policy, and default values for the parameters. The default values may be identified by the relationship manager of the car dealership. The current instant pricing structure may be outside the constraints of the user objective data or lender policy. As a result, the relationship manager may transmit the request to generate instant pricing structures. The relationship manager may include the current instant pricing structure in the request to generate instant pricing structures.

Each instant pricing structure can be generated using the lender's methodology (e.g., based on proprietary pricing algorithms) and within the constraints of the lender's underwriting policies. The lender's methodology may involve calculating an APR, a required down payment, loan term, monthly payments for the user purchasing the given vehicle, using the user information, soft pull information, and information about the given vehicle.

Generation API 106 may identify one or more parameters associated with the attribute. As described above, the attribute may be received in the request. Alternatively, the attribute may be identified by generation API 106 using dealer or user information.

As an example, the parameters to generate an instant pricing structure may include the term, sales price, cash down, trade value, warranty, gap, participation, rebate, alternative vehicles, or the like. Each of the parameters may have corresponding values. These values, when adjusted, may affect the values of the instant pricing structure. For example, adjustment of the parameters may affect Loan-to-Value (LTV), Payment to Income (PTI) ratio, Front End percentage (FE %), Front End Amount (FE$), Total Amount Financed, etc. As such, generation API 106 may identify the one or more parameters identified for a given attribute, on the basis that varying the one or more parameters would allow the instant pricing structure objects to remain within the constraints or requirements of the attribute, user objective data, policy data, and any other constraints. Other constraints may include a customer's credit profile, a lender's credit policy, customer equity, income, economic profile, asset profile (i.e., vehicle details), or the like.

Generation API 106 may also determine a threshold that one or more parameters may be adjusted. As a non-limiting example, the threshold may be determined based on one or more of a dealer's historical sales data, predetermined information, information associated with the attribute.

For example, in the event the attribute is a “low front end value” and the identified one or more parameters are front end value and loan term, generation API 106 may determine a threshold for how much the front end value may be adjusted and how much the loan term may be adjusted. Generation API 106 may determine that because the attribute is a “low front end value,” the front end value may not be higher than a predetermined amount or percentage of the final sales price. Furthermore, generation API 106 may also determine, based on the dealer's historical sales data, that the dealer does not finalize sales for which a front end value is lower than a given amount. As such, the threshold for the front end value may include a maximum and minimum amount. Similarly, generation API 106 may determine a minimum and maximum threshold, based for the loan term on one or more of: a dealer's historical sales data, predetermined information, information associated with the attribute.

The predetermined information may be information based on common practices in the vehicle sale and loan business. For example, predetermined information about a loan term may include common loan terms for vehicle loans. In this regard, the predetermined information for a loan term may indicate that a loan term cannot extend more than 84 months, for example.

Generation API 106 may generate a plurality of instant pricing structures by incrementally varying the values of the one or more parameters, starting at the default values, within the identified thresholds. Each instant pricing structure may be generated using the lender's algorithm or methodology and using the user and specified vehicle information. More specifically, each instant pricing structure is unique for the user and the specified vehicle.

As described above, the request may include specified locked-in values. These locked-in values correspond to one or more non-adjustable parameters. The one or more non-adjustable parameters may be different than the identified one or more parameters. The one or more non-adjustable parameters may be selected based on user selection or dealer selection. Generation API 106 may use the locked-in values for the one or more non-adjustable parameters when generating each instant pricing structure.

Each instant pricing structure may be within the constraints or requirements of the attribute, the user objective data, and policy data. Moreover, each instant pricing structure may include the locked-in values for the one or more non-adjustable parameters. Generation API 106 may generate each instant pricing structure to be unique and within constraints of a given attribute, user objective data, and policy data.

Generation API 106 may transmit the plurality of instant pricing structures to smart structures filter 204. Smart structure filter 204 may filter out one or more instant pricing structures from the plurality of instant pricing structures based on various criteria. For example, in some embodiments, generation API 106 generates the plurality instant pricing structures for a dealership's entire inventory. As a result, smart structures filter 204 may filter out instant pricing structures that do not correspond to the specified vehicle received in the request.

Smart structure filter 204 may transmit the filtered plurality of instant pricing structures to optimizer engine 104. Optimizer engine 104 may generate a model and plot the filtered plurality of instant pricing structures on the model. The model may include a set of dimensions. Each of the dimensions in the set can correspond with a user objective, attribute, or default objective. For example, if the user objective data is a maximum monthly payment, then one of the dimensions may correspond with the maximum monthly payment. Moreover, if an attribute is a low rate, then a dimension may correspond with one of the dimensions.

Optimizer engine 104 may identify a set of instant pricing structures from the filtered plurality of instant pricing structures plotted on the model based on each instant pricing structure from the set being within a threshold distance of a value of a respective dimension of the set of dimensions. That is, each identified set of instant pricing structures may be selected based on its proximity to a value of the user's objective dimension, attribute dimension, or a default dimension.

For example, in the event an identified instant pricing structure is within the threshold distance to a given value of the user's objective dimension, optimizer engine 104 may determine that the identified instant pricing structure provides the maximum or best value based on the user's objective. Alternatively, in the event the identified pricing structure is within a threshold distance of a value of the attribute dimension, optimizer engine 104 may determine that the identified pricing structure matches the attribute's constraints most closely. For example, if the attribute is a low rate, the identified instant pricing structure may include the lowest rate as compared to the other filtered plurality of instant pricing structures. Moreover, optimizer engine 104 may also select an instant pricing structure that is within a threshold distance between a value of the user objective dimension and a value of the attribute dimension. This way, the identified set of instant pricing structures includes instant pricing structures that are likely to be agreed upon by the dealer and the user. This avoids having to generate multiple instant pricing structures for the same user repeatedly.

Optimizer engine 104 may rank the set of instant pricing structures based on the likelihood of the instant pricing structures being selected. The likelihood of being selected may be a numerical score determined based on a comparison of the values of a given instant pricing structure to other instant pricing structures in the set. The higher the numerical score may indicate a higher likelihood of selection. For example, the likelihood of the instant pricing structure being selected is based on a similarity of a given instant pricing structure to a previously selected final pricing structure for the dealer. Alternatively, or in addition to, the likelihood of the instant pricing structure being selected may be determined based on the proximity of the values of a given instant pricing structure to the respective attribute, input, lender credit policy, thresholds of the one or more parameters, or other constraints.

In some embodiments, each of the instant pricing structures for each set may be displayed on application 114, categorized by attribute. In other embodiments, pricing engine 102 may rank instant pricing structures for each set for the dealer and user. The rankings may be different for the dealer as compared to the user. For example, pricing engine 102 may rank the instant pricing structures for each set for the dealer based on a likelihood of a dealer to agree to the instant pricing structure s. Pricing engine 102 may determine this based on elements of previous final pricing structure data objects by the dealer. Pricing engine 102 may use the elements to identify the tendencies and preferences of the dealer. Pricing engine 102 may also use the elements to determine previous users' tendencies and preferences and use the tendencies and preferences of other users to rank the instant pricing data structures in each set for the user. The ranked instant pricing data structures for the user may be displayed on application 114. The ranked instant pricing data structures for the dealer may be displayed on application 118. In some embodiments, optimizer engine 104 may also rank the attributes based on a preference indicated by the dealer or determined by optimizer engine 104 based on information about the dealer. The interface may include each of the selected instant pricing structures categorized based on the attributes, and the attributes may be presented in a ranked order

Optimizer engine 104 may transmit the identified set of instant pricing structures to client device 110. Client device 110 may render the identified set of instant pricing structures on UI 200. A user or dealer may select one of the identified set of instant pricing structures. When the user and dealer agree to an instant pricing structure with the dealer, UI 200 may transmit a request to transform the selected instant pricing structure into a final pricing structure to server 100. A final pricing structure may be a final loan contract, which when signed may legally initiate the loan process. The final pricing structure may include additional details about the user and the loan, such as a hard credit inquiry about the user (e.g., a full credit report) and final loan details.

The request may include information about the instant pricing structure. Instead of generating a new final pricing structure in response to the request, server 100 may use information in the instant pricing structure (e.g., APR, vehicle price, loan term, or the like) and transform the instant pricing structure into a final pricing structure. The final pricing structure may include identical data as the instant pricing structure. The final pricing structure may include additional details about the user and the loan, such as a hard credit inquiry about the user (e.g., a full credit report) and final loan details. The final pricing structure may be used to obtain the loan and purchase of a vehicle. Each of the identified set of instant pricing structures may be actionable instant pricing structures.

In some embodiments, UI 200 may transmit a request to server 100 to adjust an element of an instant pricing structure of the set of instant pricing structures. Server 100 may determine a threshold amount in which the element can be adjusted so that the instant pricing structure remains within the constraints of the user objective data, attribute, policy data, locked-in values, etc. Server 100 can provide options for adjusting the element within the threshold amount to UI 200.

As a non-limiting example, a lender may include a relationship manager. The relationship manager may be responsible for approving or rejecting instant pricing structures received from dealerships. In the event the relationship manager rejects the instant pricing structure, the relationship manager may generate callback or counter-offer instant pricing structures for users at the dealership for purchasing vehicles. The instant pricing structures generated by the relationship device may be callbacks or counter-offers to the instant pricing structure generated by the dealership. Client device 110 may be operated by the relationship manager and the relationship manager may receive a instant pricing structure generated by the dealership for a user to purchase a vehicle. The instant pricing structure may be a current instant pricing structure. The current instant pricing structure may be generated by a dealership using information about the specified vehicle, the lender's credit policy, and default values for the parameters. The default values may be identified by the dealership. However, the current instant pricing structure may not be acceptable to the user (e.g., customer) or lender.

The relationship manager may transmit a request for generating instant pricing structures for a loan for a specified vehicle sold by the car dealership using UI 200. The request may include a user input specifying the user objective data (e.g., customer objective data), attributes, locked-in values for parameters, and the current instant pricing structure generated by the relationship manager. The request may further include user information, vehicle information about the specified vehicle, etc. The user information may include the user's full name, social security number, address, employment information, or other personal information, such as would be needed for credit verification or vehicle purchase. The vehicle information about the specified vehicle may include VIN, make, model, year, cost, dealership identifier, etc. The user objective data can be a maximum monthly payment, interest rate, vehicle price, loan term, or the like.

The attributes may serve as constraints or requirements when generating instant pricing structures. For example, attributes can include a ratio of the backend value of the sales price and the frontend value of the sales price, percentage of the sales price that is the backend value as compared to the total value of the vehicle, funded structured flag, the percentage of down payment, details related to the vehicle (e.g., condition of the vehicle, whether the vehicle is new or used, type of vehicle, or the like), or the like. The funded structured flag may indicate whether the dealer prefers protection for assuming the credit risk. The frontend value of the price of a vehicle may include the price of the vehicle itself. The backend value of the price of the vehicle may include warranties and maintenance of the vehicle.

Moreover, server 100 may identify an attribute. For example, the attribute may be a dealer's tendencies or preferences when agreeing upon a final pricing structure. Server 100 may identify an attribute based on previously agreed upon final pricing structures by the dealer. In some embodiments, server 100 may implement an unsupervised machine learning algorithm to identify attributes about the dealer based on the previously agreed upon final pricing structures.

Server 100 may receive the request from UI 200. Smart structures BFF 202 may format user information, vehicle information about the specified vehicle, user objective data, an attribute, locked-in values, current instant pricing structure, etc., into a payload and transmit the payload to smart structures filter 204. Smart structures filter 204 may also be an API on server 100.

Smart structures filter 204 may interface with generation API 106 to generate a plurality of instant pricing structures. Generation API 106 may use a dealer identifier to retrieve the inventory of the dealer. Generation API 106 may also use the dealer identifier to retrieve dealer information, including previously agreed upon final pricing structures, inventory information, sales records, or the like. Generation API 106 may use the inventory information to determine or confirm information about the specified vehicle. Generation API 106 may receive the dealer identifier in the request. Alternatively, generation API 106 may identify the dealer based on where the vehicle is currently listed in stock using the specified vehicle's information (e.g., VIN). Furthermore, generation API 106 may identify the dealer by identifying the seller device that transmitted the request. The seller device can correspond to a dealership.

Generation API 106 may also retrieve the credit policy of a lender from database 140. A lender may provide their methodology and policies to database 140. As an example, server 100 and database 140 may be associated with the lender. Generation API 106 can retrieve a lender's policy and methodology for generating an instant pricing structure from database 140. The lender's policy and methodology can include Bayesian regression algorithms, decision trees, pricing grids, or various equations to generate instant pricing structures. As an example, the lender's methodology may include interfacing with a third-party credit bureau to execute a soft pull for the user. Soft pulls are soft credit inquiries that do not affect the user's credit score. The user information, soft pull information, input, and information about the given vehicle can be values of parameters used to generate the instant pricing structure using the lender's policies and methodologies. Each instant pricing structure can be specifically generated based on the user's unique information and the given vehicle.

Generation API 106 may identify one or more parameters associated with the attribute. As described above, the attribute may be received in the request. Alternatively, the attribute may be identified by generation API 106 using dealer or user information. Generation API 106 may also determine a threshold that one or more parameters may be adjusted. As a non-limiting example, the threshold may be determined based on one or more of a dealer's historical sales data, predetermined information, information associated with the attribute.

The predetermined information may be information based on common practices in the vehicle sale and loan business. For example, predetermined information about a loan term may include common loan terms for vehicle loans. In this regard, the predetermined information for a loan term may indicate that a loan term cannot extend more than 84, for example.

Generation API 106 may generate a plurality of instant pricing structures by incrementally varying the values of the one or more parameters, starting at the default values of the current instant pricing structure, within the identified thresholds. Each instant pricing structure may be generated using the lender's algorithm or methodology and using the user and specified vehicle information. More specifically, each instant pricing structure is unique for the user and the specified vehicle.

As described above, the request may include specified locked-in values. These locked-in values correspond to one or more non-adjustable parameters. The one or more non-adjustable parameters may be different than the identified one or more parameters. The one or more non-adjustable parameters may be selected based on user selection or dealer selection. Generation API 106 may use the locked-in values for the one or more non-adjustable parameters when generating each instant pricing structure.

Each instant pricing structure may be within the constraints or requirements of the attribute, the user objective data, and policy data. Moreover, each instant pricing structure may include the locked-in values for the one or more non-adjustable parameters. Generation API 106 may generate each instant pricing structure to be unique and within constraints of a given attribute, user objective data, and policy data.

Generation API 106 may transmit the plurality of instant pricing structures to smart structures filter 204. Smart structure filter 204 may filter out one or more instant pricing structures from the plurality of instant pricing structures based on various criteria. For example, in some embodiments, generation API 106 generates the plurality instant pricing structures for a dealership's entire inventory. As a result, smart structures filter 204 may filter out instant pricing structures that do not correspond to the specified vehicle received in the request.

Smart structure filter 204 may transmit the filtered plurality of instant pricing structures to optimizer engine 104. Optimizer engine 104 may generate a model and plot the filtered plurality of instant pricing structures on the model. The model may include a set of dimensions. Each of the dimensions in the set can correspond with a user objective, attribute, or default objective. For example, if the user objective data is a maximum monthly payment, then one of the dimensions may correspond with the maximum monthly payment. Moreover, if an attribute is a low rate, then a dimension may correspond with one of the dimensions.

Optimizer engine 104 may identify a set of instant pricing structures from the filtered plurality of instant pricing structures plotted on the model based on each instant pricing structure from the set being within a threshold distance of a value of a respective dimension of the set of dimensions. That is, each identified set of instant pricing structures may be selected based on its proximity to a value of the user's objective dimension, attribute dimension, or a default dimension.

For example, the default dimension may be associated with a default objective. The default objective may be to identify an instant pricing structure with values closest to the values of the current instant pricing structure. This provides an instant pricing structure that is within the lender's credit policy, generated based on the user's objective information, and close to the dealership's originally generated current instant pricing structure. Therefore, optimizer engine 104 may identify an instant pricing structure including values that are the closest to the values of the current instant pricing structure.

The set of instant pricing structures may be possible callbacks (counter offers) to the current instant pricing structure. In this regard, optimizer engine 104 identifies optimized callbacks which may result in faster acceptance by the user, dealer, and lender. This configuration avoids repeatedly generating callbacks without an understanding of the user's objective, lender's objective, or the dealer's objective.

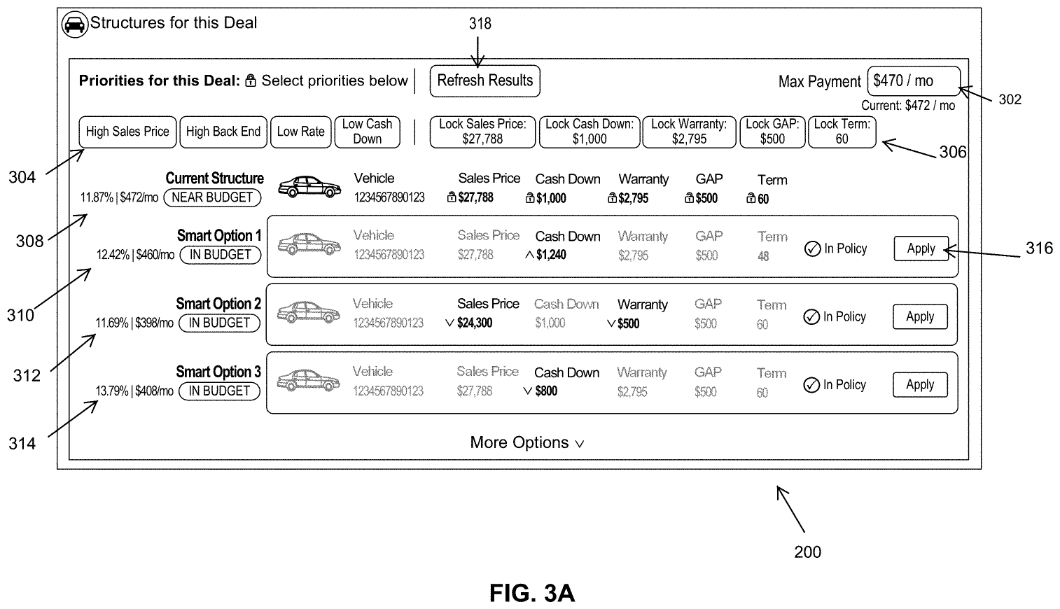

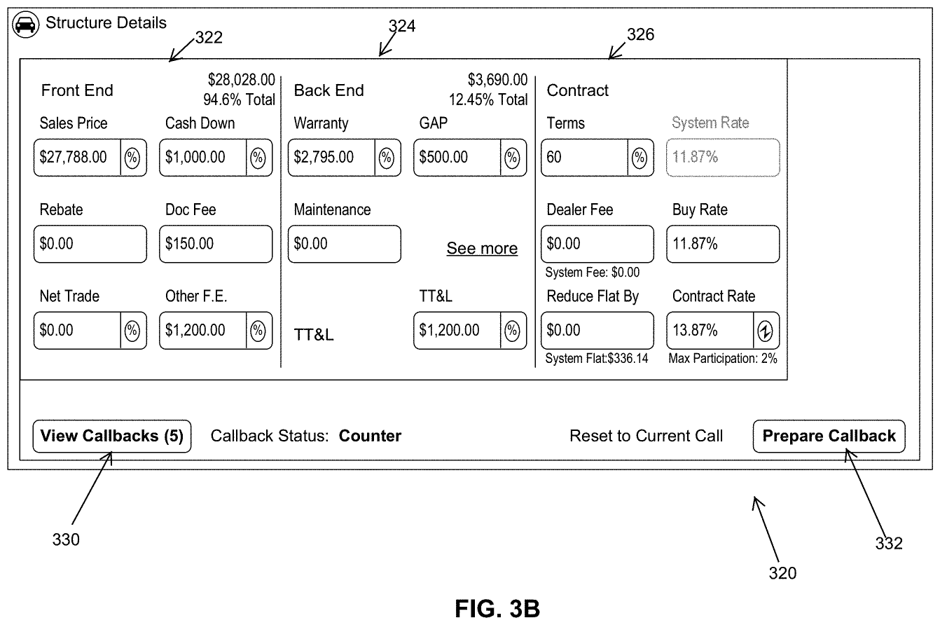

FIGS. 3A-3B illustrate example user interfaces for generating optimized data structure objects, according to some embodiments. FIGS. 3A-3B shall be described with respect to FIGS. 1-2.

With respect to FIG. 3A, UI 200 may include input box 302, attribute buttons 304, locked-in value buttons 306, a current instant pricing structure 308, smart option 1 instant pricing structure 310, smart option 2 instant pricing structure 312, and smart option 3 instant pricing structure 314. Smart option 1 instant pricing structure 310, smart option 2 instant pricing structure 312, and smart option 3 instant pricing structure 314 may be part of the set of instant pricing structures identified by optimizer engine 104.

Current instant pricing structure 308 may be an instant pricing structure that is generated using default values for each parameter of the instant pricing structure. For example, a dealership may generate current instant pricing structure 308. The default values may be identified by the dealership. The dealership may transmit current instant pricing structure 308 to a relationship manager at a lender for approval. The relationship manager may be responsible for approving instant pricing structures for purchasing vehicles at dealerships. However, current instant pricing structure 308 may not be within the constraints of the user objective data, selected attributes, lender policy, or locked-in values. The relationship manager may transmit a request to generate instant pricing structures based on user information, user objective data, lender policy information, vehicle information, current instant pricing structure 308, etc., using UI 200.

UI 200 may further include an apply button 316 for each of smart option 1 instant pricing structure 310, smart option 2 instant pricing structure 312, and smart option 3 instant pricing structure 314. A user may select apply button 316 to apply for the loan for the respective instant pricing structure. UI 200 may further include a refresh results button 318 to refresh the set of instant pricing structures rendered on UI 200.

Input box 302 may receive string values corresponding to a user objective data. For example, input box 302 may receive a numerical value corresponding to a maximum monthly payment. One or more attribute buttons 304 may be selected to constrain the set of instant pricing structures based on the attribute. Moreover, one or more lock-in value buttons 306 may be selected to lock-in a value for a particular parameter. Each of smart option 1 instant pricing structure 310, smart option 2 instant pricing structure 312, and smart option 3 instant pricing structure 314 may be constrained by a maximum monthly payment value indicated in input box 302, selected attribute buttons 304, and selected locked-in value buttons 306.

As a non-limiting example, the relationship manager (or user or dealer) may transmit a request to generate and identify a set of instant pricing structures from a plurality of instant pricing structures. The request may include user objective data of a maximum monthly payment of $470, one or more attributes corresponding to one or more selected attribute buttons 304, one or more locked-in values corresponding to one or more selected locked-in value buttons 306, user information, current instant pricing structure 308, and vehicle information. The attributes may be high sales price, high back end, low rate, or cash down. The locked-in values may be for parameters such as sales price, cash down, warranty, GAP, or lock term.

Server 100 may receive the request from UI 200. Generation API 106 may identify one or more parameters corresponding to one or more attributes that may be adjusted so that the instant pricing structure is constrained by user objective data, policy data, selected one or more attributes and selected one or more locked-in values. Generation API 106 may also identify thresholds for the one or more parameters. Generation API 106 may generate a plurality of instant pricing structures by incrementally varying the values of the one or more parameters, starting at the default values, within the identified thresholds. Generation API 106 may use the lender information, dealer information, user information, user objective data, one or more attributes, current instant pricing structure 309, and one or more locked-in values to generate the plurality of instant pricing structures.

Optimizer engine 104 may generate a model and plot the plurality of instant pricing structures on the model. The model may include a set of dimensions. Each dimension may correspond to user objective data, default objective data, an attribute, or the like. Optimizer engine 104 may identify a set of instant pricing structures from the model based on the distance between a respective instant pricing structure and a value of a respective dimension. Optimizer engine 104 may identify smart option 1 instant pricing structure 310, smart option 2 instant pricing structure 312, and smart option 3 instant pricing structure 314 from the model.

Server 100 may transmit the identified set of instant pricing structures to client device 110. Client device 110 may render the set of instant pricing structures on UI 200. As shown in FIG. 3A, smart option 1 instant pricing structure 310, smart option 2 instant pricing structure 312, and smart option 3 instant pricing structure 314 have monthly payment amounts lower than the user objective data of $470.

UI 200 may indicate particular parameters and their respective values of current instant pricing structure 308, smart option 1 instant pricing structure 310, smart option 2 instant pricing structure 312, and smart option 3 instant pricing structure 314. For example, interest rate, monthly payment, whether the instant pricing structure is within a desired budget, vehicle information, sales price, cash down, warranty, GAP, term, and whether the instant pricing structure is “in-policy.”

UI 200 may highlight the values of smart option 1 instant pricing structure 310, smart option 2 instant pricing structure 312, and smart option 3 instant pricing structure 314 that are different from current instant pricing structure 308. For example, UI 200 may highlight cash down for smart option 1 instant pricing structure 310 because the cash down value for smart option 1 instant pricing structure 310 is $1240, and the cash down value for current instant pricing structure 308 is $1000. UI 200 may highlight sales price and warranty for smart option 2 instant pricing structure 312 because the sale price of smart option 2 instant pricing structure 312 is $24,300 and the warranty is $500 while the sales price of current instant pricing structure 308 is $27,788 and the warranty is $2,795. UI 200 may highlight cash down for smart option 3 instant pricing structure 314 because the cash down value for smart option 3 instant pricing structure 314 is $800, and the cash down value for current instant pricing structure 308 is $1000.

The relationship manager (or user or dealer) may select new attributes, user objective data, or locked-in values on UI 200 and select refresh results button 316. In response to selecting refresh results button 316, a new request may be transmitted to server 100 to generate and identify a different set of instant pricing structures based on the newly selected attributes, user objective data, or locked-in values. Server 100 may generate and identify the different set of instant pricing structures based on the newly selected attributes, user objective data, or locked-in values. Server 100 may render the different set of instant pricing structures on UI 200.

With respect to FIG. 3B, UI 200 may include structure details 320. Structure details 320 may be details related to a selected structure from UI 200. Structure details 320 may include front end details 322, back end details 324, and contract details 326. Structure details 320 may further include view callbacks button 330 and prepare callback button 332.

Front end details 322 may include input boxes for sales prices, cash down, rebate, doc fee, net trade, and other front end. The input boxes may include values of the selected instant pricing structure. A dealer may adjust the values in the input boxes to adjust the selected instant pricing structure. Adjusting one of the values may affect the other values in the other input boxes.

Back end details 324 may include input boxes for warranty, GAP, maintenance, and Tax, Title, and License (TT&L). The input boxes may include values of the selected instant pricing structure. A dealer may adjust the values in the input boxes to adjust the selected instant pricing structures.

Contract details 326 may include input boxes for terms, system rate, dealer fee, buy rate, reduce flat by, and contract rate. The input boxes may include values of the selected instant pricing structure. A dealer may adjust the values in the input boxes to adjust the selected instant pricing structures. However, the value for system rate may not be adjusted.

View callbacks button 330 may be selected to view counter offers to the selected instant pricing structure. Moreover, prepare callback button 332 may be selected to prepare a callback or counter offer.

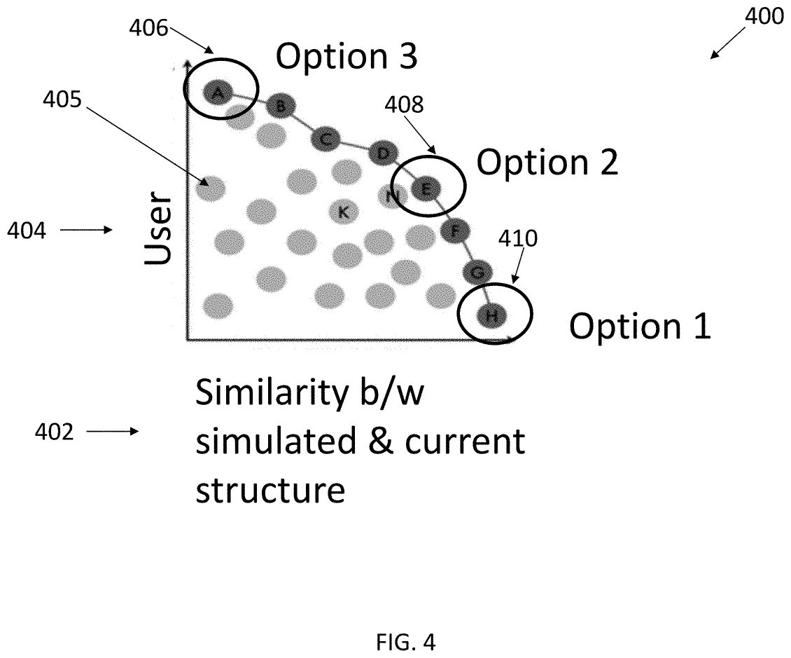

FIG. 4 illustrates a model for identifying the set of data object structures, according to some embodiments. FIG. 4 shall be described with reference to FIG. 1.

As described above, once generation API 106 generates the plurality of data structure objects (i.e., instant pricing structures), optimizer engine 104 may identify a set of data structure objects from the plurality. Optimizer engine 104 may generate model 400. Model 400 may include a set of dimensions. For example, model 400 may include dimension 402 and dimension 404. Dimension 402 may run along the x-axis, and dimension 404 may run along the y-axis. Each of the set of dimensions may correspond to user objective data, a default objective, an attribute, or the like.

For example, dimension 402 may correspond to a default objective of similarity between a simulated and current structure. The current structure may correspond with current structure 308, as shown in FIG. 3A. More specifically, the car dealership may generate a current instant pricing structure using benchmark or default values for each parameter using user information and information about the specified vehicle. The current instant pricing structure may not be within the constraints of the user objective data, attribute, locked-in values, lender policy, or the like. The default values may be predetermined by server 100, the user, or the dealer. As a result, a default objective may be a similarity between a respective instant pricing structure of the plurality of instant pricing structures and the current instant pricing structure. The similarity may be determined based on the differences in the values of each of the parameters of the respective instant pricing structure and the current instant pricing structure. For example, two values corresponding to two parameters may be different in a first instant pricing structure, and the current instant pricing structure and three values corresponding to three parameters may be different in a second instant pricing structure and the current instant pricing structure. In this case, the first instant pricing structure may be more similar to the current instant pricing structure as compared to the second instant pricing structure.

The values of dimension 402 may correspond with a score representing the similarity between a respective instant pricing structure and the current instant pricing structure. Optimizer engine 104 may generate a score indicating a similarity for a respective instant pricing structure and the current instant pricing structure. Optimizer engine 104 may compare the values of the parameters of the respective instant pricing structure and the values of the parameters of the current instant pricing structure. For each instance that the values of the parameters of the respective instant pricing structure matches or is within a threshold amount of the values of the parameters of the current instant pricing structure, optimizer engine 104 increases the score. The higher the score, the more similar the respective instant pricing structure is to the current instant pricing structure.

Dimension 404 may correspond to user objective data. User objective data may be a maximum monthly payment, desired loan term, maximum interest rate, maximum cash down, or the like. The value at the top of dimension 404 may correspond with the maximum value of the user objective. The value at the bottom of dimension 404 may correspond with the least value of the user objective. For example, if the user objective is a maximum monthly payment of $500, the top most value of dimension 404 may be $350, because $350 may be the lowest possible monthly payment based on the price of the vehicle, locked-in values, attribute, policy data, user information, or the like. The bottom most value of dimension 404 may be $500.

Optimizer engine 104 may plot each of the plurality of instant pricing structures on model 400. Each of the instant pricing structures may be represented by points, such as point 405. Optimizer engine 104 may plot each instant pricing structure based on the values of the parameters of each instant pricing structure and as the parameters correspond with a respective dimension. For example, as indicated above dimension 404 may correspond with user objective data. In the event user objective data is a maximum monthly payment amount, optimizer engine 104 may plot a point representing a respective instant pricing structure at a position with respect to dimension 404 which reflects the value of the monthly payment amount in the respective instant pricing structure. Therefore, the maximum monthly payment amount is $500 and the top most value of dimension 404 may be $350. If the monthly payment amount of the instant pricing structure is $370, optimizer engine 104 may plot the point representing the respective instant pricing structure at a position with respect to dimension 404 close to the top most value of dimension 404.

Optimizer engine 104 may generate a curve around outside the points representing the instant pricing structures. Point 406 may be at a first end of the curve, and point 410 may be at the second end of the curve.

Optimizer engine 104 may identify a set of instant pricing structures from the curve based on each respective instant pricing structure being within a threshold distance of a value of a respective dimension. For example, optimizer engine 104 may identify instant pricing structure 1 corresponding to point 406 because point 406 is closest to the highest value on dimension 404. Instant pricing structure 1 may represent maximum value for the user's objective. For example, if the user's objective was maximum monthly payment, point 406 may be within a threshold distance of a value of dimension 404, representing the lowest possible monthly payment.

Optimizer engine 104 may identify instant pricing structure 2 corresponding to point 408 because point 408 is within a threshold distance of a value of dimension 404. More specifically, point 408 is in the middle of the curve. This allows the user and dealer to understand the path toward maximizing the user's objective.

Optimizer engine 104 may identify instant pricing structure 3 corresponding to point 410 because point 410 is within a threshold distance of a value of dimension 402. As indicated above, dimension 402 may correspond with the default objective of similarity between simulated and current structure. Optimizer engine 104 may identify an instant pricing structure 3 corresponding to point 410 because point 410 is closest to the highest value on dimension 402. Instant pricing structure 3 may include values most similar to the values of the current structure compared to the other instant pricing structures of the plurality of instant pricing structures. For example, instant pricing structure 3 may include the least number of values different from the values of the current instant pricing structure compared to the other instant pricing structures in the plurality of instant pricing structures. The highest value of dimension 402 may represent the most similarity between a respective instant pricing structure and a current instant pricing structure. Instant pricing structure 3 may provide the user with an easier negotiation point with the dealer.

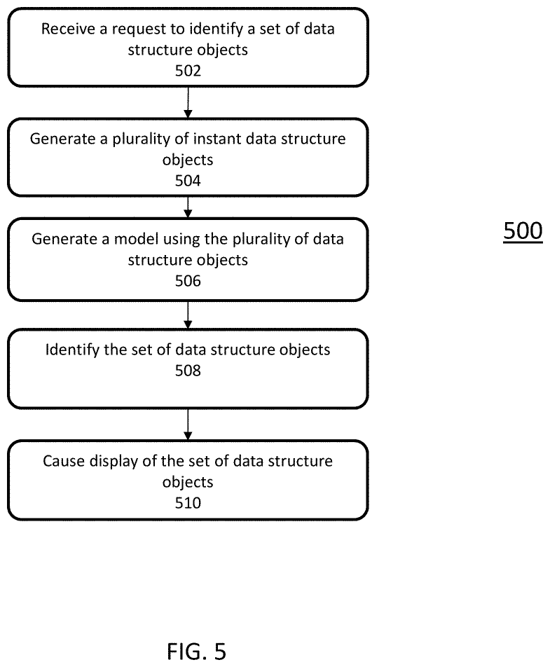

FIG. 5 is a flowchart illustrating a process for generating and identifying a set of data structure objects, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 4, as will be understood by a person of ordinary skill in the art.

Method 500 shall be described with reference to FIGS. 1-2. However, method 500 is not limited to those example embodiments.

In operation 502, server 100 receives a request to identify a set of data structure objects from a plurality of data structure objects for a specified user and specified vehicle and based on an attribute and user objective data. The request may be transmitted by a relationship manager at a lender. The data structure objects may be instant pricing structures for loans to purchase vehicles. Each instant pricing structure may be generated using parameters. The request may be received from client device 110. Client device 110 may be a user device or a dealer device. The request includes the specified user, specified vehicle, attribute, user objective data, and a current instant pricing structure generated by the dealership. The request may also include locked-in values, which correspond with non-adjustable parameters. The relationship manager, user, or dealer may interact with UI 200 rendered on client device 110 to transmit the request.

In operation 504, generation API 106 generates a plurality of data structure objects for the specified vehicle and specified user by adjusting a value for a parameter corresponding to the attribute by an incremental amount within a threshold. The values for the parameter may be adjusted starting at the corresponding value of the parameter of the current instant pricing structure. This occurs while maintaining each data structure object of the plurality of data structure objects within constraints of the user objective data, policy data, and the attribute. Each data structure object or instant pricing structure may be distinct and specified to the user and the vehicle. In some embodiments, one or more parameters may be identified. Each of the one or more parameters may be adjusted to generate a different data structure object or instant pricing structure. Moreover, different combinations of parameters may be adjusted to generate different data structure objects or instant pricing structures.

In operation 506, optimizer engine 104 may generate a model using the plurality of data structure objects. The model includes a set of dimensions. Each of the set of dimensions may correspond with an attribute, user objective data, default objective, or the like. The plurality of data structure objects or instant pricing structures may be plotted on the model. Optimizer engine 104 may draw a curve around the outer edge of the model.

In operation 508, optimizer engine 104 identifies the set of data structure objects from the plurality of data structure objects. Each data structure object of the set is within a threshold distance to a value corresponding to at least one dimension of the model's set of dimensions. For example, the value may correspond with maximizing the user's objective. Optimizer engine 104 may identify the set of data structure objects or instant pricing structures based on corresponding points on the curve generated optimizer engine 104.

In operation 510, server 100 causes display of the set of data structure objects on a UI 200. UI 200 may be rendered on client device 110. A relationship manager, user, or dealer may interact with UI 200 to select one of the set of data structure objects or instant pricing structures. Moreover, the relationship manager, user or dealer may adjust the values of the set of data structure objects or instant pricing structures or transmit a new request to generate a new set of data structure objects or instant pricing structures.

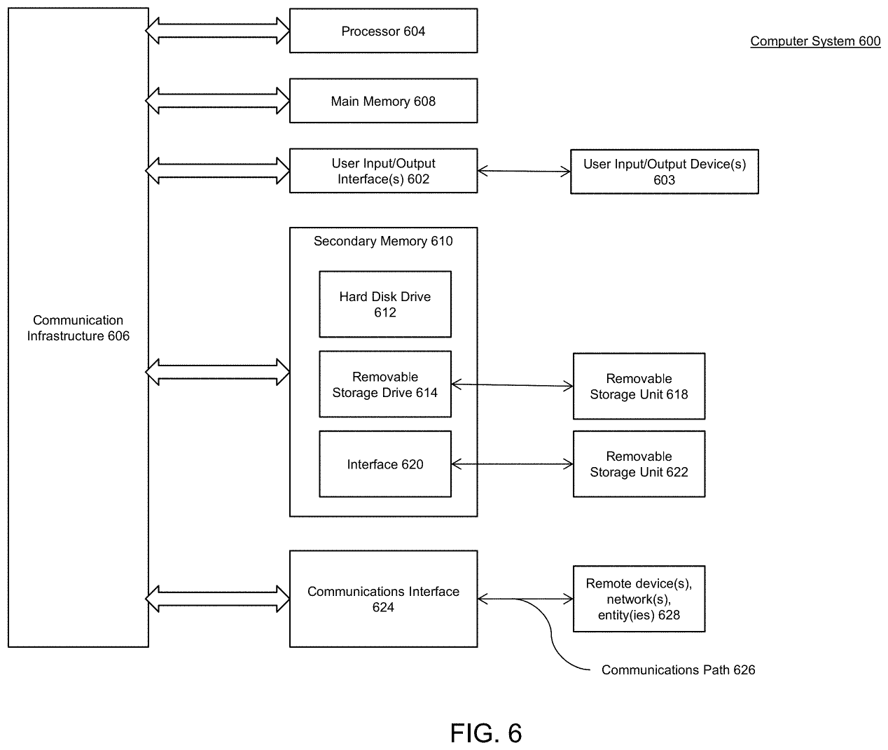

Various embodiments can be implemented, for example, using one or more computer systems, such as computer system 600 shown in FIG. 6. Computer system 600 can be used, for example, to implement method 500 of FIG. 5. Furthermore, computer system 600 can be at least part of server 100, client device 110, and database 140, as shown in FIG. 1. For example, computer system 600 route communication to various applications. Computer system 600 can be any computer capable of performing the functions described herein.

Computer system 600 can be any well-known computer capable of performing the functions described herein.

Computer system 600 includes one or more processors (also called central processing units, or CPUs), such as a processor 604. Processor 604 is connected to a communication infrastructure or bus 606.

One or more processors 604 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 can include one or more levels of cache. Main memory 608 has stored therein control logic (i.e., computer software) and/or data.

Computer system 600 can also include one or more secondary storage devices or memory 610. Secondary memory 610 can include, for example, a hard disk drive 612 and/or a removable storage device or drive 614. Removable storage drive 614 can be a floppy disk drive, a magnetic tape drive, a compact disk drive, an optical storage device, tape backup device, and/or any other storage device/drive.

Removable storage drive 614 can interact with a removable storage unit 618. Removable storage unit 618 includes a computer usable or readable storage device having stored thereon computer software (control logic) and/or data. Removable storage unit 618 can be a floppy disk, magnetic tape, compact disk, DVD, optical storage disk, and/any other computer database. Removable storage drive 614 reads from and/or writes to removable storage unit 618 in a well-known manner.

According to an exemplary embodiment, secondary memory 610 can include other means, instrumentalities, or other approaches for allowing computer programs and/or other instructions and/or data to be accessed by computer system 600. Such means, instrumentalities, or other approaches can include, for example, a removable storage unit 622 and an interface 620. Examples of the removable storage unit 622 and the interface 620 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 can further include a communication or network interface 624. Communication interface 624 enables computer system 600 to communicate and interact with any combination of remote devices, remote networks, remote entities, etc. (individually and collectively referenced by reference number 628). For example, communication interface 624 can allow computer system 600 to communicate with remote devices 628 over communications path 626, which can be wired and/or wireless, and which can include any combination of LANs, WANs, the Internet, etc. Control logic and/or data can be transmitted to and from computer system 600 via communication path 626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, the method comprising:
receiving, by one or more computing devices, a request to identify a set data structure objects from a plurality of data structure objects for a specified vehicle and a specified user and based on user objective data and an attribute;
generating, by the one or more computing devices, a plurality of data structure objects for the specified vehicle and the specified user by adjusting a value for a parameter corresponding to the attribute by an incremental amount within a threshold, while maintaining each data structure object of the plurality of data structure objects within constraints of the user objective data, policy data, and the attribute;
generating, by the one or more computing devices, a model using the plurality of data structure objects, wherein the model includes a set of dimensions and the plurality of data structure objects are plotted on the model with respects to the set of dimensions;
identifying, by the one or more computing devices, the set of data structure objects from the plurality of data structure objects, wherein each data structure object of the set is within a threshold distance to a value of at least one of the dimension of the set of dimensions of the model; and
causing, by the one or more computing devices, display of the set of data structure objects on a user interface (UI).

2. The method of claim 1, wherein the at least one dimension of the set of dimensions corresponds with the user objective data or the attribute.

3. The method of claim 1, further comprising receiving, by the one or more computing devices, the user objective data via an input received by the UI.

4. The method of claim 1, wherein the threshold for the parameter is determined based on historical data associated with the parameter and a predetermined limit associated with the parameter.

5. The method of claim 1, further comprising transforming, by the one or more computing devices, a data structure object from the set of data structure objects into a final data structure object, in response to a selection of the data structure object and independent of further input associated with the specified user.

6. The method of claim 1, wherein each data structure object is generated using a set of parameters including the parameter corresponding to the attribute.

7. The method of claim 6, wherein one or more of the set of parameters other than the parameter corresponding to the attribute corresponds to a non-adjustable predetermined value.

8. A system, the system comprising:
a memory; and
a processor coupled to the memory, the processor configured to:
receive a request to identify a set data structure objects from a plurality of data structure objects for a specified vehicle and a specified user and based on user objective data and an attribute;
generate a plurality of data structure objects for the specified vehicle and the specified user by adjusting a value for a parameter corresponding to the attribute by an incremental amount within a threshold, while maintaining each data structure object of the plurality of data structure objects within constraints of the user objective data, policy data, and the attribute;
generate a model using the plurality of data structure objects, wherein the model includes a set of dimensions and the plurality of data structure objects are plotted on the model with respects to the set of dimensions;
identify the set of data structure objects from the plurality of data structure objects, wherein each data structure object of the set is within a threshold distance to a value of at least one of the dimension of the set of dimensions of the model; and
cause display of the set of data structure objects on a user interface (UI).

9. The system of claim 8, wherein the at least one dimension of the set of the dimensions corresponds with the user objective data or the attribute.

10. The system of claim 8, the processor further configured to receive the user objective data via an input received by the UI.

11. The system of claim 8, wherein the threshold for the parameter is determined based on historical data associated with the parameter and a predetermined limit associated with the parameter.

12. The system of claim 8, the processor further configured to transform a data structure object from the set of data structure objects into a final data structure object, in response to a selection of the data structure object and independent of further input associated with the specified user.

13. The system of claim 8, wherein each data structure object of the plurality of data structure objects is generated using a set of parameters including the parameter corresponding to the attribute.

14. The system of claim 13, wherein one or more of the set of parameters other than the parameter corresponding to the attribute corresponds to a non-adjustable predetermined value.

15. A non-transitory computer-readable medium having instructions stored thereon, execution of which, by one or more processors of a device, cause the one or more processors to perform operations comprising:
receiving a request to identify a set data structure objects from a plurality of data structure objects for a specified vehicle and a specified user and based on user objective data and an attribute;
generating a plurality of data structure objects for the specified vehicle and the specified user by adjusting a value for a parameter corresponding to the attribute by an incremental amount within a threshold, while maintaining each data structure object of the plurality of data structure objects within constraints of the user objective data, policy data, and the attribute;
generating a model using the plurality of data structure objects, wherein the model includes a set of dimensions and the plurality of data structure objects are plotted on the model with respects to the set of dimensions;
identifying the set of data structure objects from the plurality of data structure objects, wherein each data structure object of the set is within a threshold distance to a value of at least one of the dimension of the set of dimensions of the model; and
causing display of the set of data structure objects on a user interface (UI).

16. The non-transitory computer-readable medium of claim 15, wherein the at least one dimension of the set of dimensions corresponds with the user objective data.

17. The non-transitory computer-readable medium of claim 15, wherein the threshold for the parameter is determined based on historical data associated with the parameter and a predetermined limit associated with the parameter.

18. The non-transitory computer-readable medium of claim 15, the operations further comprising transforming a data structure object from the set of data structure objects into a final data structure object, in response to a selection of the data structure object and independent of further input associated with the specified user.

19. The non-transitory computer-readable medium of claim 15, wherein each data structure object of the plurality of data structure objects is generated using a set of parameters including the parameter corresponding to the attribute.

20. The non-transitory computer-readable medium of claim 19, wherein one or more of the set of parameters other than the parameter corresponding to the attribute corresponds to a non-adjustable predetermined value.
